(19) United States
(12) Patent Application Publication
(10) Pub. No.: US 2017/0156305 A1
(43) Pub. Date: Jun. 8, 2017

(54) Insulating Device for Building Foundation Slab

(71) Applicant: Tony Hicks, Roanoke, IN (US)

(72) Inventor: Tony Hicks, Roanoke, IN (US)

(21) Appl. No.: 14/962,764

(22) Filed: Dec. 8, 2015

(51) Int. Cl. A01M 1/24; A01M 17/00; E04B 1/80; A01M 21/00; E04B 1/72; E02D 31/00

(52) U.S. Cl. CPC A01M 1/24; E04B 1/72; E02D 31/00; E04B 1/80; A01M 21/00; A01M 17/00

(57) ABSTRACT

A device for insulating the slab foundation of a building, where the device includes: an asymmetric three sided water repellent layer having a sloped portion; an insulating layer, adjacent to and within the water repellent layer; and an insect repellent layer disposed against one side of the insulating layer between the water repellent layer and the insulating layer.

### BACKGROUND

1. Field of the Art

This invention is related to building construction. More particularly, this invention is an insulation device for slab foundations of residential and commercial buildings.

2. Description of the Prior Art

Most residential and smaller commercial buildings in the United States are built using standardized building practices. One reason for this consistency is a set of uniform building codes that apply across the country. Another reason is cost. The techniques used to build homes, for example, produce reliable structures quickly at relatively low cost. Homes in the United States are generally built using the following procedure: grading and site preparation, foundation construction, framing, window and door installation, roofing, siding, electrical, plumbing, HVAC, insulation, drywall, underlayment, trim, and interiors.

One of the first steps in erecting a residential or commercial building is constructing a foundation. Houses, for example, are generally built on a crawlspace, basement, or slab foundation.

The slab is the easiest foundation to build. It is a flat concrete pad poured directly on the ground. It takes very little site preparation, very little formwork for the concrete, and very little labor to create.

For a typical slab foundation, a concrete perimeter is embedded in the ground around three feet deep. The slab further comprises a four to six inch thick flat surface atop the embedded perimeter. A layer of gravel lies beneath the slab, and a sheet of plastic lies between the concrete and the gravel to keep moisture out. Wire mesh and/or steel reinforcing bars are implanted in the concrete for additional structural integrity. In colder climates, the concrete perimeter has to extend deep enough into the ground to remain below the frost line in winter.

Slab foundations work well on level sites in warmer climates. However, in colder climates, where the ground freezes in the winter, use of an non-insulated slab results in cold floors and higher heating costs as heat is lost from the home to the outside. In fact, slabs lose energy primarily due to heat conducted outward and through the perimeter of the slab. Insulating the exterior edge of the slab in most sections of the country can reduce winter heating bills by 10% to 20%.

Thus, a need exists for a thermal barrier that can be attached to a slab foundation for residential or commercial buildings to prevent heat loss from the building through the slab. State energy and building codes regarding slab insulation and energy savings are often guided by model codes such as the International Energy Conservation Code (“IECC”). These objectives are generally expressed in terms of R-values and U-values.

Thermal conductivity is the rate of thermal conduction through a material per unit area per unit thickness per unit temperature differential. The inverse of conductivity is resistivity (or R per unit thickness). Thermal conductance is the rate of heat flux through a unit area at the installed thickness and any given delta-T.

The R-value is a measure of thermal resistance used in the building and construction industry. Under uniform conditions, R-value it is the ratio of the temperature difference across an insulator to the heat flux (heat transfer per unit area) through it. Thus, R-value for any particular material or apparatus is the unit thermal resistance. R-value is expressed as the thickness of the material divided by the thermal conductivity. For the thermal resistance of an entire section of material, instead of the unit resistance, divide the unit thermal resistance by the area of the material. A higher the R-value denotes a more effective insulator. U-value is the reciprocal of R-value.

Experimentally, thermal conduction for a particular material is measured by placing the material in contact between two conducting plates and measuring the energy flux required to maintain a certain temperature gradient. Generally, the R-value of insulation is measured at a steady temperature, usually about 70° F. with no forced convection.

In the United States, R-value is expressed as h*ft²*° F./Btu, where h=hours; ft=feet; and ° F.=Fahrenheit temperature. The conversion between SI and US units of R-value is 1 h·ft²·° FBtu=0.176110 K·m²/W. Polyisocyanurate (polyiso for short) foam has the highest R-value per inch (R-6.5 to R-6.8) of any rigid insulation. However, the thickness can be increased or decreased to achieve a desired R-value. This type of rigid foam usually comes with a reflective foil facing on both sides, so it can also serve as a radiant barrier in some applications. Polyiso board is more expensive than other types of rigid foam. Extruded polystyrene (XPS) rigid foam is usually blue or pink in color, with a smooth plastic surface. XPS panels typically aren't faced with other material. The R-value is about 5 per in. This type of rigid foam won't absorb water like polyiso and is stronger and more durable than expanded polystyrene, so it's probably the most versatile type of rigid foam. XPS falls between polyiso and expanded polystyrene in price. Expanded polystyrene (EPS) is the least-expensive type of rigid foam and has the lowest R-value (around R-3.8 per in.). It's also more easily damaged than the other types of rigid foam. Dr. Energy Saver Home Services, Rigid Insulation Board: R-value Packed into a Rigid Foam Panel, available at http://www.drehergysaver.com/insulation/insulation-materials/rigid-insulation-board.html (last visited Dec. 27, 2012).

The IECC for 2012 details recommended R-values and U-values for slab building foundations, as shown in the following table where R-values are minimums and U-values are maximums.

TABLE 1

| | | SLAB R-VALUE |
|---|---|---|
| CLIMATE | FENESTRATION | & DEPTH |
| ZONE | U-FACTOR | (h*ft²*° F./Btu) |
| 1 | NR | 0 |
| 2 | 0.40 | 0 |
| 3 | 0.35 | 0 |
| 4 except Marine | 0.35 | 10, 2 ft |
| 5 and Marine 4 | 0.32 | 10, 2 ft |
| 6 | 0.32 | 10, 4 ft |
| 7 and 8 | 0.32 | 10, 4 ft |

A “climate zone” number is a description of the climate in a particular geographic area, based on the number of heating days, the number of cooling days, the amount of precipitation, and other factors in a particular geographic region. The IEEC tables below show specific climate zone definitions.

TABLE 2
INTERNATIONAL CLIMATE ZONE DEFINITIONS
MAJOR CLIMATE TYPE DEFINITIONS
Marine (C) Definition—Locations meeting all four criteria:
Mean temperature of coldest month between −3° C. (27° F.) and 18° C.
(65° F.)
Warmest month mean <22° C. (72° F.)
At least four months with mean temperatures over 10° C. (50° F.)
Dry season in summer. The month with the heaviest precipitation in the
cold season has at least three times as much precipitation as the month
with the least precipitation in the rest of the year. The code season is
October through March in the Northern Hemisphere and April through
September in the Southern Hemisphere.
Dry (B) Definition—Locations meeting the following criteria: Not
Marine and
Pin < 0.44×
(TF − 19.5)
[Pcm < 2.0×
(TC + 7) in SI
units] where:
Pin = Annual precipitation in inches (cm)
T = Annual mean temperature in ° F. (° C.)
Moist (A) Definition—Locations that are not Marine and not Dry.

TABLE 3
INTERNATIONAL CLIMATE ZONE DEFINITIONS

| ZONE | THERMAL CRITERIA | |
|---|---|---|
| NUMBER | IP Units | SI Units |
| 1 | 9000 < CDD50° F. | 5000 < CDD10° C. |
| 2 | 6300 < CDD50° F. :: 9000 | 3500 < CDD10° C. :: 5000 |
| 3A and | 4500 < CDD50° F. :: 6300 | 2500 < CDD10° C. :: 3500 |
| 3B | AND HDD65° F. :: 5400 | AND HDD18° C. :: 3000 |
| 4A and | CDD50° F. :: 4500 AND | CDD10° C. :: 2500 AND |
| 4B | HDD65° F. :: 5400 | HDD18° C. :: 3000 |
| 3C | HDD65° F. :: 3600 | HDD18° C. :: 2000 |
| 4C | 3600 < HDD65° F. :: 5400 | 2000 < HDD18° C. :: 3000 |
| 5 | 5400 < HDD65° F. :: 7200 | 3000 < HDD18° C. :: 4000 |
| 6 | 7200 < HDD65° F. :: 9000 | 4000 < HDD18° C. :: 5000 |
| 7 | 9000 < HDD65° F. :: 12600 | 5000 < HDD18° C. :: 7000 |
| 8 | 12600 < HDD65° F. | 7000 < HDD18° C. |

The Building America marine climate corresponds to those portions of IECC climate zones 3 and 4 located in the “C” moisture category. Prior efforts to address the unmet needs in the art are described in the following patents.

U.S. Pat. No. 5,295,337 discloses an isolation element for the isolation of vibrations and/or heat, which propagate/s in a medium such as soil, as well as the application of isolation element in an isolation arrangement. The isolation element is characterized by a rectangular plate-shaped block with one or several on one or both of the two side surfaces attached cushion-shaped bodies. The isolation arrangement is characterized by a trench in the ground, in the bottom of the trench preferably vertically anchored guide rods placed in a row, in the trench poured stabilizing slurry as well as on the guide rods threaded and from the bottom of the trench to the orifice and preferably along the whole length of the trench on top of each other and/or next to each other stacked isolation elements placed on their edges.

U.S. Pat. No. 5,352,064 discloses a collapsible spacer for disposition between a form for a concrete foundation member and the underlying soil includes voids to allow the spacer to deform permanently and occupy a reduced volume when upheaving of the soil occurs. The spacer is fabricated from a material, such as expanded polystyrene foam, whose structural strength is not significantly altered by exposure to moisture.

U.S. Pat. No. 5,433,049 discloses a prefabricated building system for the laying of the foundations for a heated building with a beam structure above an enclosed, unventilated creep space. The foundations are constructed from base plates made of concrete, foundation beams made of concrete with internal cellular plastic, and ventilation grids for ventilation. The foundation beams consist of an externally reinforced high concrete slab with thick, cast-on-cellular plastic insulation on the inside. The creep space can be inspected more easily thanks to the considerable height of the foundation beams. The thick cellular plastic insulation on the foundation beams enables surplus heat to be utilized, so that the laying of the foundations can take place at a reduced foundation depth. The foundations can be laid using a crane, and can be adapted to the requirements of the project. The invention also relates to a method and means for the production of elements from which the foundations can be constructed.

U.S. Pat. No. 5,544,453 discloses a building construction in which a floor story of the building rests on a foundation which, in turn, lies on the ground. An insulated and separate service space is disposed beneath the floor story of the living accommodation, with room for accommodating heating, ventilation, and water supply systems as well as electrical systems. The insulated service space is formed mainly by the floor story of the building, a ground insulating layer, and a surrounding foundation wall. A gap is provided between the insulated service space and the first story with the gap extending along the inside of each foundation wall. A heating source is provided within the service space and exhausts heated air directly into the service space with the heated air flowing upwardly through the gap into the first story area.

U.S. Pat. No. 5,615,525 discloses a rigid, thermoplastic foam board useful in below-grade residential and commercial insulating and drainage applications. The board defines a plurality of oriented channels extending therein along the board. The channel extends into the board through a relatively narrow first opening at the face into a relatively wide first zone. The channel then further extends into the board from the first zone through a relatively narrow second opening into a second zone. The board provides superior water drainage, and protects a below-grade building wall from excessive moisture. Further disclosed is a method for using the foam board in below-grade applications.

U.S. Pat. No. 5,617,693 discloses a truss which is premanufactured and shipped to a job site for the construction of supper-insulated buildings walls has a two-by-four stud which is joined to a two-by-two stud positioned in spaced parallel relation to the first stud to form a twelve inch wide insulation cavity. The two-by-two stud is spaced from the two-by-four stud by spacers and is rigidly supported by diagonal cross braces. The braces and spacers are joined to the two-by-four stud by truss plates. A foundation, is especially designed to accommodate the wall truss members. The truss has a sill extension 8½ inches wide formed of two-by-twos. The extension extends downwardly from the truss structure to provide an insulation face across the front of a step in the foundation. The wall trusses may be manufactured with the same equipment as utilized in the construction of floor and rafter trusses formed of dimensional two-by-fours. The ability to shop-fabricate the wall trusses using truss plates means that engineered truss members for each job can be supplied which minimize utilized material while, at the same time, saving considerable labor over on-site construction.

U.S. Pat. No. 5,704,172 discloses a rigid polymer foam board suitable for use in a foundation insulation system. The foam board has a face defining a plurality of grooves therein which traverse in a crossing, diagonal configuration. The groove configuration facilitates the application of insecticides/termiticides in foundation insulation systems employing rigid foam boards on the exterior of the foundation.

U.S. Pat. No. 5,740,636 discloses a weather block and vent member across the space between the ends of joists resting on a plate having between them an insulation blanket having a vapor barrier adjacent a ceiling on the bottom of the joists. The member blocks the flow of air towards the end of the vapor barrier and the ceiling and sometimes down past the plate in a wall inside covering and down pass the inside covering and the vapor barrier on the blanket insulation between the wall studs, and redirects it upwards along the rafters. It also blocks the flow of air across the plate, to eliminate the Bernoulli Effect thereat which was operative to suck the out the air between the wall-stud insulation vapor barrier and the wall interior covering. The weather block and vent is field adapted to the parameters of the building and is factory scored for easy field adaptation and so that it can be shipped flat for transportation economies.

U.S. Pat. No. 5,791,107 discloses a building, particularly in the context of a nuclear installation. The building is formed with an outer shell and an inner shell which form an intermediate space therebetween. A sealing element is disposed in the intermediate space. The sealing element is gas tight, it envelopes the inner shell, and it is largely freely movable perpendicularly to the surfaces of the shells defining the intermediate space. Pressure fluctuations, particularly pressure waves, originating on the inside of the building are received and equalized by the sealing element, while the gas-tightness of the sealing element is largely assured.

U.S. Pat. No. 5,806,252 discloses a waterproofing system and method for hydraulic structures which includes rigid sheets of synthetic material connected with flexible hinges made of sheets of synthetic material. Mechanical anchoring hold the rigid sheets in place.

U.S. Pat. No. 5,979,131 discloses an exterior insulation and finish system is produced for exterior construction having a primary weather proofing layer formed by a finish coat and a secondary seal is provided intermediate of the various layers of exterior insulation between a sheathing substrate and insulation board. The secondary seal layer also serves to adhesively secure the insulation board to the sheathing substrate.

U.S. Pat. No. 6,076,313 discloses a method and apparatus for providing a controlled environment for storing, producing, growing and/or processing at least one item. The method includes the steps of introducing an item into an enclosed storage space separated from an interior of a first thermal mass layer by a vessel formed of a heat conductive material. The exterior of the first thermal mass layer is then thermally isolated and the temperature of the first thermal mass is regulated to control the temperature in the enclosed storage space.

U.S. Pat. No. 6,122,887 discloses a geomembrane made from a custom blend of polyethylene copolymers, for protecting waterproofing courses from impact and pressure damage of debris resting against the waterproof course. A slip sheet configuration reduces surfaces stress due to earth movement and subsurface cracking thereby maintaining the protective course intact without any effect on the waterproofing layers. The geomembrane is available as lightweight rolls which can be easily be handled by one man. The film is installed horizontally in continuous sheets with few adhesive joints. Installation begins by applying a thick brush coat of the selected waterproofing membrane material (usually a rubber coat but may be any waterpoofing material). The film is unrolled along the wall, held up into position and secured using plastic self-sealing plugs and/or plastic termination bars. Concrete nails are used to attach the self-sealing plugs or termination bar to the wall. If termination bar is selected the film is extended up beyond the bar approximately 8″ and folded down over the termination bar after attachment. Staples into the termination bar can be used to hold the film down creating a nicely detailed upper edge.

U.S. Pat. No. 6,360,496 discloses a circular building structure which comprises a plurality of columnar structures, each of which extends from a point below ground level to a desired height above ground level and wall structures positioned between the columnar structures and forming a substantially circular exterior wall with the columnar structures. The wall structures and the columnar structures enclose a substantially circular inner space. The building structure further includes a central hub positioned above the inner space. A plurality of trusses for supporting a roof are provided. Each of the trusses is joined to a respective one of the columnar structures and to the central hub. The inner space is divided into a perimetric space and an interior space by an interior wall which is concentric with the exterior wall. The perimetric space, in a preferred construction, is divided by walls into at least one passageway and a number of rooms. The interior space, in a preferred construction, is left as an undivided space which serves as a common area for eating, cooking, and other activities.

U.S. Pat. No. 6,477,811 discloses a method of construction of a damp-proof basement includes disposing a water-permeable palette layer on a bottom surface of the interior of the basement and spaced from an outer wall of the basement, disposing a water-impermeable vent layer over the palette layer, disposing a reinforced-concrete slab on the vent layer and spaced from the outer wall, and disposing an inner wall at a periphery of the concrete slab and spaced from the outer wall. A damp-proof basement construction includes a water-permeable palette layer, disposed on a bottom surface of the interior of the basement, spaced from an outer wall of the basement. A water-impermeable vent layer is disposed over the palette layer. A reinforced-concrete slab is disposed on the vent layer, spaced from the outer wall. An inner wall is disposed at a periphery of the concrete slab, spaced from the outer wall.

U.S. Pat. No. 6,568,136 discloses a method for building a floor in a structure, such as a house, is designed to utilize the heat stored in the earth. The method includes the steps of building a continuous footing made of concrete on a location that corresponds to the location of an outer circumferential groundsill that is planned to be built around the outer circumference of a structure being built, providing a stone layer inside the continuous footing by placing stones to cover all of the area on the planned floor location, placing the outer circumferential groundsill on the continuous footing, placing an inside groundsill inside the outer circumferential groundsill and across the outer circumferential groundsill so that the inside groundsill can have its upper edge flush with the upper edge of the outer circumferential groundsill, placing concrete for forming an underfloor concrete layer along the respective upper edges of the outer circumferential groundsill and inside groundsill within the planned floor location and then flattening the upper surface of the resulting underfloor concrete layer, and placing flooring finish boards or slabs on the flattened surface of the underfloor concrete layer after the concrete becomes hardened. The floor that is finally obtained is capable of utilizing the heat stored in the earth and the like. The inside groundsill has anchor bolts previously installed that permit an easy mounting of columns or posts on the inside groundsill.

U.S. Pat. No. 7,313,891 discloses a system for finishing a concrete structure to increase the amount of useable space in a building. The finishing system comprises a plurality of connectable panels. An insulation layer is secured to the rear surface of the panels. The insulation layer has a generally flat front surface that is secured to the rear surface of the panels. The insulation layer also provides an uneven rear surface that is positioned adjacent to the existing basement foundation wall, and a pair of uneven side surfaces. The uneven rear and side surfaces of the insulation layer provide a plurality of grooves or dimples that allow moisture and air to move freely between the wall structure and the insulation layer. The panels and insulation layer are mounted to the existing wall structure by mounting brackets.

U.S. Pat. No. 7,407,004 discloses a structure utilizing geothermal energy capable of effectively utilizing a thermal energy in an underground constant temperature layer while using a supplementary heater and an air conditioner and natural energies such as solar heat or solar light, wind power, and water power in order to prevent limited fossil energies such as petroleum, gases, and coal from being exhausted, wherein an insulating wall (A) formed of a plurality of insulation panels (1) connected to each other and extending from a ground surface (4) to the underground constant temperature layer (21) is buried in the ground while surrounding a building (22) adhesively to the ground exposed portion and the underground buried portion of a foundation (5).

U.S. Pat. No. 7,735,271 discloses a system for forming an insulating vapor barrier in a building is especially suited for forming an insulating vapor barrier in a crawl space beneath a building. The system includes a series of separate vapor barrier panels that can be attached around a wall. A ground level vapor barrier can be sealed to the insulating vapor barrier panels, which can be sealed to each other and along a top edge to the wall. The individual vapor barrier panels include an insulating foam member with a vapor resistant liner laminated thereto and extending beyond the edges of the insulating foam member to provide space for securing and sealing multiple vapor barrier panels to form a continuous insulating vapor barrier. Mechanical or hook and loop fasteners can be provided to secure the top edges of the vapor barrier liners to the wall and bottom edges to a ground liner.

U.S. Pat. No. 7,908,801 discloses a material and method for insulating and providing a drainage path for a foundation wall includes a non-woven thermoplastic board being for insulating and providing a drainage path for a foundation wall. The non-woven thermoplastic board has a thermal resistance of an R-value per inch thickness of at least 1. The non-woven thermoplastic board also has vertical drainage ability per inch thickness of at least 135 Gallons/Hour/Lineal-Foot/inch at a pressure of 500 pounds per square foot (psf).

U.S. Pat. No. 7,966,780 discloses a wall structure for absorbing or transferring heat from or to the ground, the wall structure comprising a footing for the wall structure disposed in the ground below grade extending in the longitudinal direction of the wall structure, a vertical wall supported on and extending longitudinally in the direction of the footing, the vertical wall extending upwardly from the footing above grade to a predetermined height, and having upper, lower, interior, exterior and end surfaces, a sheath of insulation for enveloping the vertical wall's upper, end, interior and exterior surfaces and thermal conductors disposed in the wall structure to be in thermal communication with one another, at least some of the conductors extending outwardly from the footing into the ground, the thermal conductors facilitating heat transfer between the ground and the vertical wall.

U.S. Pat. No. 8,011,144 discloses a slab edge forming and insulating system including edge members and support braces. The edge members include an elongated shell having an upright portion with an insulated inside surface, an upper portion and a lower portion. Each of the upper and lower portions have formed edges. Open cross sectioned support braces having upper and lower formed edges for engaging the formed edges of the elongated shell are fixed to a footing and connected to the edge members. The edge members form and insulate the edges of the poured concrete of the slab while the open cross sectioned support braces receive the poured concrete of the slab and thus anchor the edge members to the edge of the slab.

U.S. Pat. No. 8,215,083 discloses a previously formed unitary building exterior envelope product is provided, comprising: a mineral fiber insulation board including a binder having a hydrophobic agent and is resistant to liquid water-penetration and has first and second major surfaces, an exterior facing material, which resists air infiltration and liquid water penetration, laminated to the first major surface, the exterior facing material being permeable to water vapor, and a continuous interior facing laminated to the second major surface, so that the second major surface is resistant to liquid water-penetration and is permeable to water vapor. The section of product is mounted to an exterior side of a plurality of framing members of an exterior wall of a building, so that the interior facing faces the framing members. An exterior layer is mounted to the framing members using a connection device that passes through the section of product, with the facing material facing the exterior layer.

Despite the above described efforts, there remains a need for an inexpensive, robust, simple, fully effective thermal barrier that can be attached to a slab foundation for residential or commercial buildings to prevent heat loss from the building through the slab.

### SUMMARY

The present invention addresses the unmet need of highly functional slab foundation insulation. An advantage of the present invention is that once installed the slab insulation device provides an R-value of at least about 5 inch of apparatus thickness. Another advantage of the present invention is that when installed it provides a U-value of at most about 0.20 inch of apparatus thickness. An additional advantage of the present invention is that when installed it provides a reduction in heat loss through the slab of at least about 20% and as much as over 60%.

These and other aspects, features, and advantages of the present invention will become more readily apparent from the attached drawings and the detailed description of the preferred embodiments, which follow.

### BRIEF DESCRIPTION OF THE DRAWINGS

The present invention will be understood more fully from the detailed description given hereinafter and from the accompanying drawings of exemplary embodiments of the present invention. However, the drawings and descriptions herein should not be taken to limit the invention; they are for explanation and understanding only.

FIG. 1 is a cross sectional view of a typical monolithic building foundation slab with a prior art insulation system.

FIG. 2 is a cross sectional view of a typical non-monolithic building foundation slab with a prior art insulation system.

FIG. 3 is a side elevation view of a slab insulation device according to an exemplary embodiment of the present invention.

FIG. 4 is a perspective view of a slab insulation device according to an exemplary embodiment of the present invention.

Like reference numerals refer to like parts throughout the several views of the drawings.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

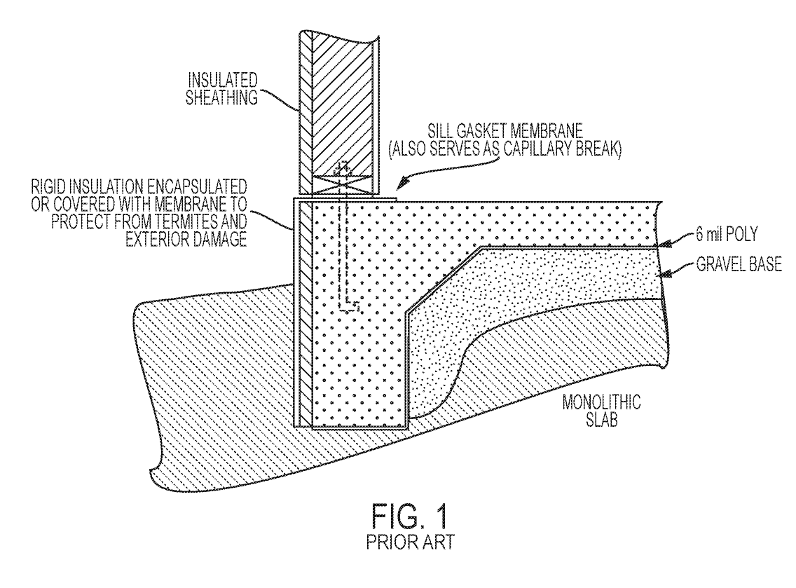

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, there is shown a typical monolithic “floating” slab for the foundation of a residential or commercial building with a prior art insulation system. As shown in FIG. 1, a typical, monolithic, floating slab foundation system comprises a concrete slab; a gravel layer; strength enhancing, preferably steel, reinforcement members within the slab.

As shown in FIG. 1, this prior art system may further comprise a rigid insulated sheathing disposed against an exterior edge of the slab and a plastic or rubber gasket membrane disposed on the ground facing, exterior wall of the rigid sheathing. The membrane functions to protect the insulation from damage due to pest infestation or moisture.

Referring still to FIG. 1, an exterior wall of a residential or commercial building disposed on top of the slab foundation and the membrane is shown. The building wall may have exterior and interior insulated sheathing.

One problem with the prior art system shown in FIG. 1 is that a break exists between the above ground and below ground exterior insulation. Consequently, significant heat can escape the building through the slab and between the two insulation segments.

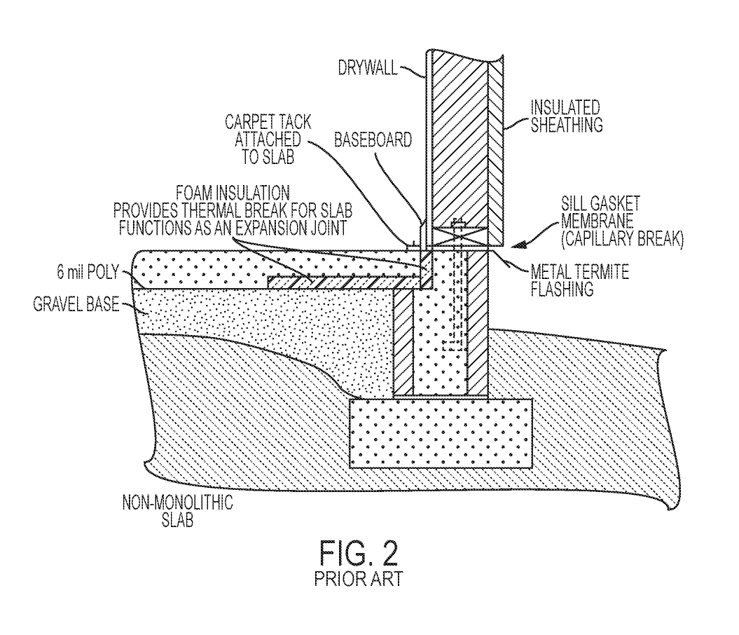

Referring now to FIG. 2, there is shown a typical non-monolithic “floating” slab for the foundation of a residential or commercial building with a prior art insulation system. As shown in FIG. 2, a typical, monolithic, floating slab foundation system generally comprises a concrete slab; a gravel layer; and strength enhancing, steel reinforcement members within the slab.

As shown in FIG. 2, the slab is poured such that it comprises a generally horizontal top and a plurality of vertical walls disposed around the perimeter of the horizontal top. The walls are entrenched in ground, preferably at a depth of about 3 feet. As further illustrated in FIG. 2, the perimeter of the slab rests on a “footer.” The slab further includes a plurality of reinforcing members disposed vertically within the slab. The reinforcing members are oriented such that they cross from the perimeter walls of the slab into and through the horizontal top portion of the slab.

Referring again to FIG. 2, the horizontal top of the slab rests atop a layer of gravel. A polymer membrane is disposed atop the layer of gravel, and a horizontal layer of foam insulation is disposed between the polymer membrane and the bottom of the horizontal portion of the slab. The foam insulation provides a thermal break for the slab and functions as a mechanical expansion joint. The polymer membrane prevents moisture from damaging the horizontally disposed foam insulation layer.

Referring again to FIG. 2, there is shown a frame around the vertical walls of the slab. The frame itself has two vertical walls that sandwich the vertical perimeter walls of the slab as shown in FIG. 2.

As further illustrated in FIG. 2, the exterior walls of a building rest on the slab such that they are generally collinear with the perimeter walls of the slab. The walls of the building generally comprise an interior drywall layer and an exterior insulated sheathing layer.

Referring still to FIG. 2, a polymer membrane is disposed between the bottom of the building exterior walls and the top of the horizontal portion of the slab.

A problem with the prior art systems shown in FIGS. 1 and 2, is that the interior flooring in such a system cannot be secured without breaking or coming loose in the corners such that certain desirable floorings, such as tile cannot be used. Past methods such as bringing the interior foam to the top of the slab with a beveled edge on the top of the slab have caused defection between the slab and footer area of slab, separation between slab and footer area of slab due to lack of a monolithic pour with the foam being the barrier.

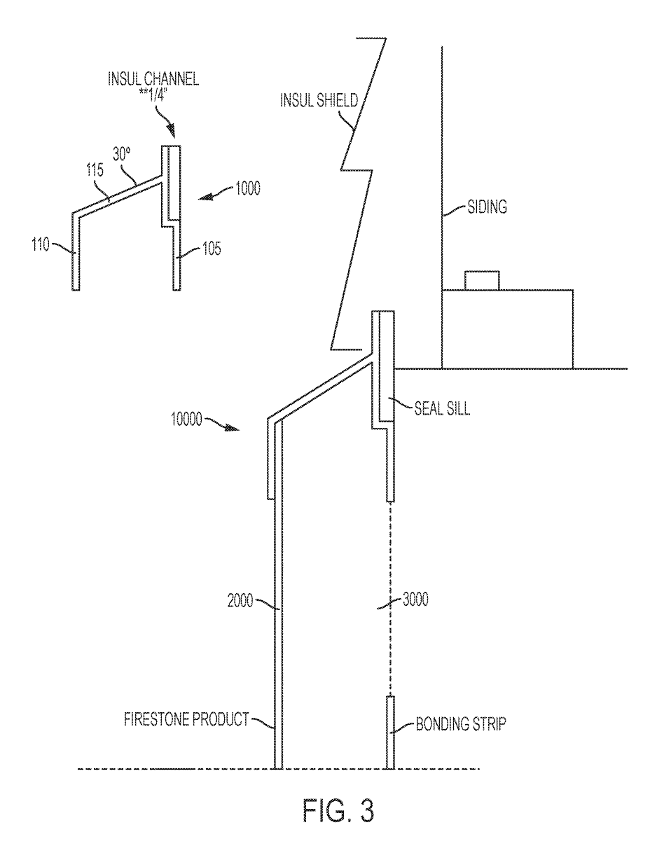

Referring now to FIG. 3, there is shown a side elevation view of an exemplary embodiment of an apparatus 10000 according to the present invention. As illustrated in FIG. 3, insulation apparatus 10000 comprises a water repelling shield layer 1000. Shield 1000 comprises generally straight vertical components 105 and 110 connected by a sloped horizontal component 115. In one preferred embodiment, vertical component 110 is about 1.5 inches tall, and opposing, vertical component 105 is about 3.5 inches tall. Horizontal component 115 connects to the top of shorter vertical component 105 and preferably slopes at an angle of about 30 degrees until it connects with the opposing (taller) vertical component.

In the preferred embodiment of the present invention, shield 1000 is comprised of a generally water repellent material. As further illustrated in FIG. 3, shield 1000 further comprises a vertical “lip” 120 by which shield 1000 is attached to the side of a building near the foundation. In the preferred embodiment of the present invention, components 150, 110, 115, and 120 of shield layer 1000 are comprised of a single extruded, molded, or machined piece. However, those of skill in the art will appreciate that shield 1000 may comprise multiple pieces connected by welding, adhesion, or other known manufacturing methods.

Referring still to FIG. 3, shield 3000 is disposed on top of and attached to an insulating layer 3000. Insulating layer 3000 comprises a material selected from the group consisting of extruded foam, polyisocyanurate foam, expanded foam, insulated foil bubble wrap, and blown insulation. Additionally, insulating layer 3000 may comprise additives selected from the group consisting of an insecticide, an herbicide, and a fungicide. Preferably, the material of insulating layer 3000 comprises has an R-value of at least about 5 per inch of material thickness.

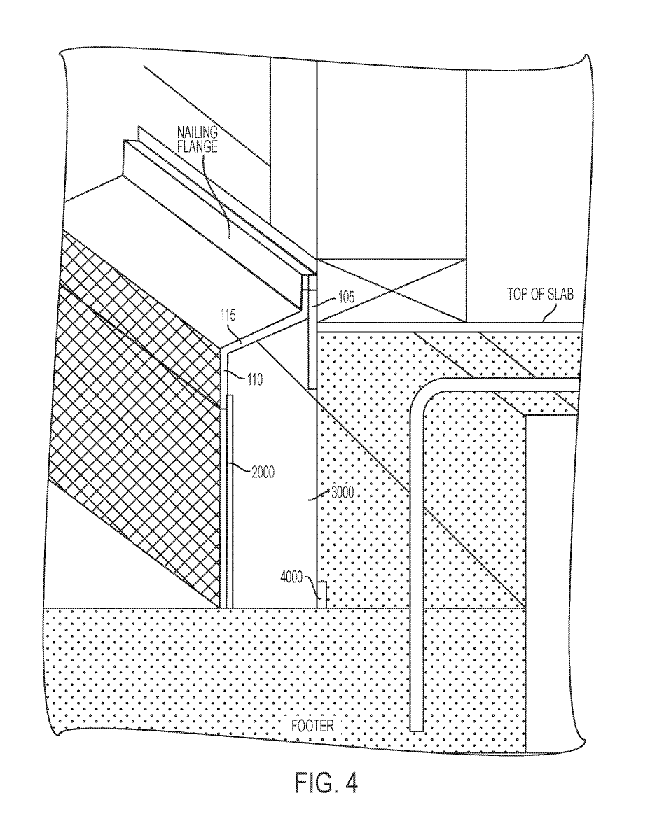

As shown in FIG. 3, insulating layer 3000 comprises a generally cuboid shape that is vertically elongated when viewed from the side. The depth, as illustrated in FIG. 4, a perspective view of apparatus 10000, of insulating layer 3000 may be of any desired length.

Returning to FIG. 3, apparatus 10000 further comprises an insect repellent and/or moisture repellent barrier 2000 disposed against the out side (opposite building) of insulating layer 3000 between vertical shield member 110 of shield 1000 and insulating layer 3000. In a preferred embodiment, the overall height of apparatus 10000 is about 12 to 14 inches.

Turning now to FIG. 3 and to FIG. 4 collectively, there is shown apparatus 10000 in use with building having a slab foundation. As illustrated in FIGS. 3 and 4, apparatus 10000 has one side that abuts and is attached to a building, such as a house, having a slab foundation. The second side of apparatus 10000 faces away from the building.

As illustrated in FIG. 4, apparatus 10000 directly abuts the slab foundation of a building and it attached thereto via bonding strip 4000 which is disposed on the house side of apparatus 10000 near the bottom of the same.

Referring again to FIGS. 3 and 4, apparatus 10000 further comprises vertical flange 120, which extends vertically up from horizontal member 115 at the intersection of member 115 and 105. Apparatus 10000 is further connected to a building via flange 120. In the exemplary embodiments shown in FIGS. 3 and 4, flange 120 is attached to an adjacent building by a plurality of fasteners, specifically nails 10. Apparatus 10000 may further comprise a seal 5000 between flange 120 and the adjacent building. However, those of skill in the art will appreciate that other attachments means could be used, such as adhesives, other mechanical fasteners, snap fit connections or the like. The extruded shield 1000 is overlapped by the siding of the building, and it allows rain to run off the building without affecting apparatus 10000, which stops air infiltration between the slab and ambient conditions.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A system for insulating the slab foundation of a building, said system comprising: an asymmetric channel, said channel comprising a vertical side, a sloped top and stepped side wherein said sloped top is disposed between and connects said vertical side and said stepped side; an R-10, insect resistant foam inner layer disposed within said channel.

2. The device of claim 1, wherein the device is prefabricated and comprises a material selected from the group consisting of extruded foam, polyisocyanurate foam, expanded foam, insulated foil bubble wrap, and blown insulation.

3. The device of claim 1, wherein the material comprises an additive selected from the group consisting of an insecticide, an herbicide, and a fungicide.

4. The device of claim 1, wherein the device has an R-value of at least about 5 per inch of material thickness.
